(19) United States
(12) Patent Application Publication
(10) Pub. No.: US 2006/0146081 A1
(43) Pub. Date: Jul. 6, 2006

(54) Validation of consumables

(75) Inventors: Kris Vandermeulen, Bomem (BE); Jos Vleurinck, Oordegem (BE); Geert Heyse, Sini-Katelijne-Waver (BE)

Correspondence Address: PILLSBURY WINTHROP SHAW PITTMAN, LLP, P.O. BOX 10500, MCLEAN, VA, 22102, US

(73) Assignee: Esselte, Sint-Niklaas (BE)

(21) Appl. No.: 10/540,548

(22) PCT Filed: Dec. 23, 2003
(86) PCT No.: PCT/EP03/14992

§ 371 Date: Feb. 22, 2006

(30) Foreign Application Priority Data
Dec. 24, 2002 (GB) 0230200.8

(51) Int. Cl. B41J 29/38

(52) U.S. Cl. 347/14

(57) ABSTRACT

A printing apparatus using a consumable associated with an identifier the apparatus comprising, printing means for printing an image onto an image receiving substrate reading means for reading the identifier: storage means for holding a list of any previously used identifiers associated with empty consumables, and a processor arranged to compare the identifier read by the reading means with the list of any previously used identifiers and to generate an invalid indication if there is a match.

The present invention relates to the validation of consumables in the context of thermal printers.

Thermal printers are widely known and generally comprises a printing means comprising a thermally activatable printhead for printing onto an image receiving tape. Typically, the image receiving tape has an upper layer for receiving an image and a removable liner layer or backing layer secured to the upper layer by a layer of adhesive, such that after an image has been printed the liner layer or backing layer can be removed and the image receiving tape can be stuck down in the form of a label. Such thermal printers include cutters for cutting off a length of image receiving tape after the image has been printed. Such thermal printers operate with a consumable in the form of image receiving tape, or any other image receiving substrate such as heat-shrink tubes, magnetic, iron-on labels, plastic strips, etc.

In addition, the printer can utilise an ink ribbon cassette which supplies ink ribbon in overlap with the image receiving tape at the printhead.

The term “consumable” is used herein to denote any appropriate form of providing image receiving tape or image transferring substance. A number of forms of consumables are known in the art, including cassettes which comprise a housing in which is located a supply of image receiving tape. Cassettes are generally usable once only, such that once the image receiving tape has been consumed, the cassette (including the housing) is thrown away.

Another type of consumable is a holder, which comprises a spool around which image receiving tape is wound. The spool may or may not be driven, and generally comprises a plastic component.

Another type of consumable is a roll of tape without a permanent holder, for example wound on a paper core. These are termed “supplies”.

As already mentioned, in thermal printers, an image is generally generated by activation of a thermal printhead against an ink ribbon cassette, such that ink from the ink ribbon is transferred onto the image receiving tape at a print zone. So-called direct thermal tapes are also available, in which an image is created directly onto the direct thermal tape without the interposition of an ink ribbon cassette. The term “consumable” also encompasses ink ribbon or other thermal transfer materials.

In all of these situations however a common problem exists, which is that of validation of the consumable itself for use in the tape printer. Consumables can be easily pirated, in the sense that an unauthorised manufacturer can copy an existing consumable for use in a printing apparatus. Such consumables tend to have lower quality than legitimately manufactured consumables and can cause technical problems when used in a printing apparatus. For example, the tapes can ruck or slip, or not carry an image properly. Also they can import dust or dirt into the printer.

An aim of the present invention is to ensure that only legitimately manufactured consumables can be used in a printing apparatus. Reference is made to U.S. Pat. No. 5,821,975 (Francotyp-Postalia AG & Co.) which relates to a franking apparatus using an ink ribbon cassette. The ink ribbon cassette carries an authorisation code which is monitored by the printer. Only valid authorisation codes are accepted for use in the printer for protection against piracy. This patent also describes a way of monitoring usage of the ink ribbon.

However, this arrangement does not prevent a pirate from copying the ink ribbon cassette, including the authorisation code itself. Therefore, this disclosure does not fully solve the problem outlined above.

According to one aspect of the invention there is provided a printing apparatus using a consumable associated with an identifier, the apparatus comprising: printing means for printing an image onto an image receiving substrate; reading means for reading the identifier; storage means for holding a list of any previously used identifiers associated with empty consumables; and a processor arranged to compare the identifier read by the reading means with the list of any previously used identifiers and to generate an invalid indication if there is a match.

The consumable can be a supply of image receiving substrate or a thermal transfer material.

Another aspect of the invention provides a consumable providing at least one of image receiving substrate and thermal transfer material and carrying an identifier indicative of the origin of the consumable.

Another aspect provides in combination, a printing apparatus and a consumable associated with an identifier, wherein the printing apparatus comprises: printing means for printing an image onto an image receiving tape; reading means for reading the identifier; storage means for holding a list of any previously used identifiers associated with empty consumables; and a processor arranged to compare the identifier read by the reading means with the list of any previously used identifiers and to generate an invalid indication if there is a match.

A further aspect provides a method of operating a printing apparatus which is adapted to receive a consumable, the method comprising: reading an identifier from the consumable, comparing the identifier against a list of any previously used identifiers associated with empty consumables, and generating an invalid indication if there is a match.

The invalid indication can take the form of an internal control signal which disables the printer and/or causes an error message to be displayed.

Preferably, the identifier is provided on an RF ID tag on the consumable, and the reading means comprises an RF coil.

A consumable may be in the form of a cassette, a holder or the supply itself (as in a roll of tape). There are particular advantages where the RF tag is associated with the supply itself, and an RF tag can easily be implemented in the supply itself. That is, it does not have to be part of a cassette housing or holder.

Preferably, the storage means holds a table having a plurality of identifier fields associated with respective status fields. The processor can be arranged to load any identifiers read from the consumables which have not previously been used into the table, and to update the status field based on the usage of the consumable. When a consumable is empty, that identifier can be moved on to a blacklist to ensure that subsequent consumables utilising that identifier are not used in the printing apparatus.

For a better understanding of the present invention and to show how the same may be carried into effect, reference will now be made by way of example to the accompanying drawings, in which:

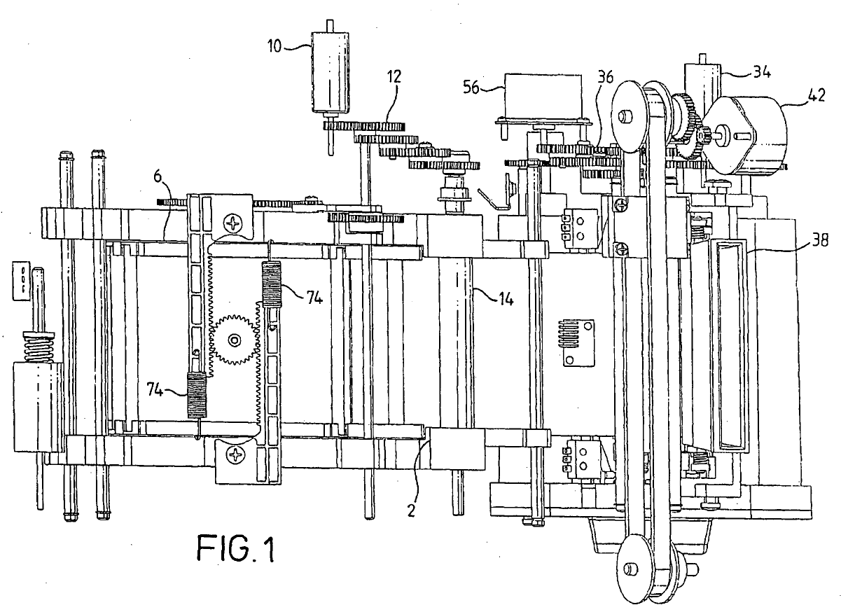

FIG. 1 is a plan view of the mechanical arrangement of a printing apparatus;

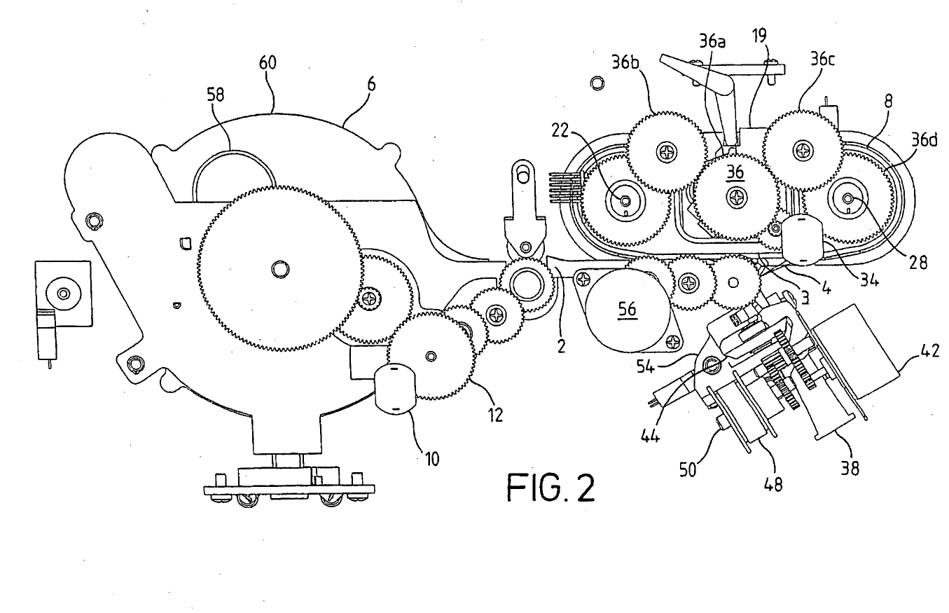

FIG. 2 is a side view of the mechanical arrangement of the printing apparatus;

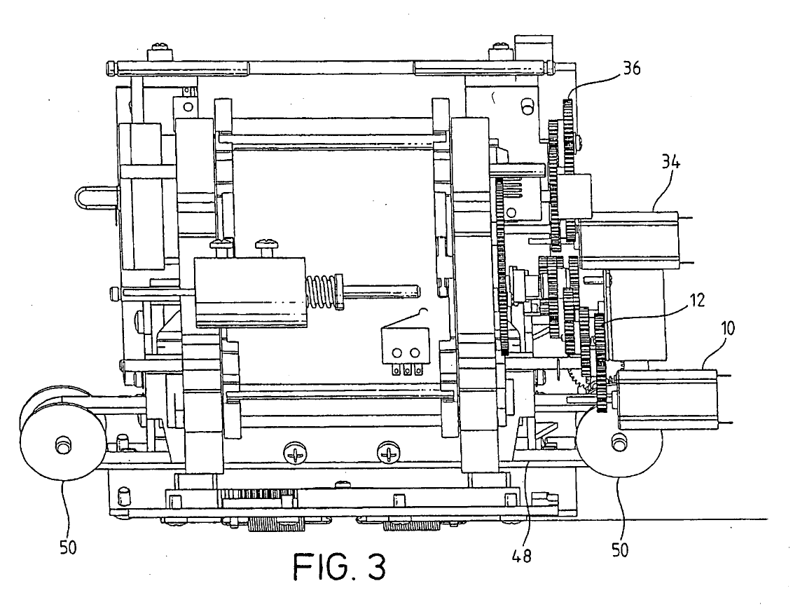

FIG. 3 is a front view of the mechanical arrangement of the printing apparatus;

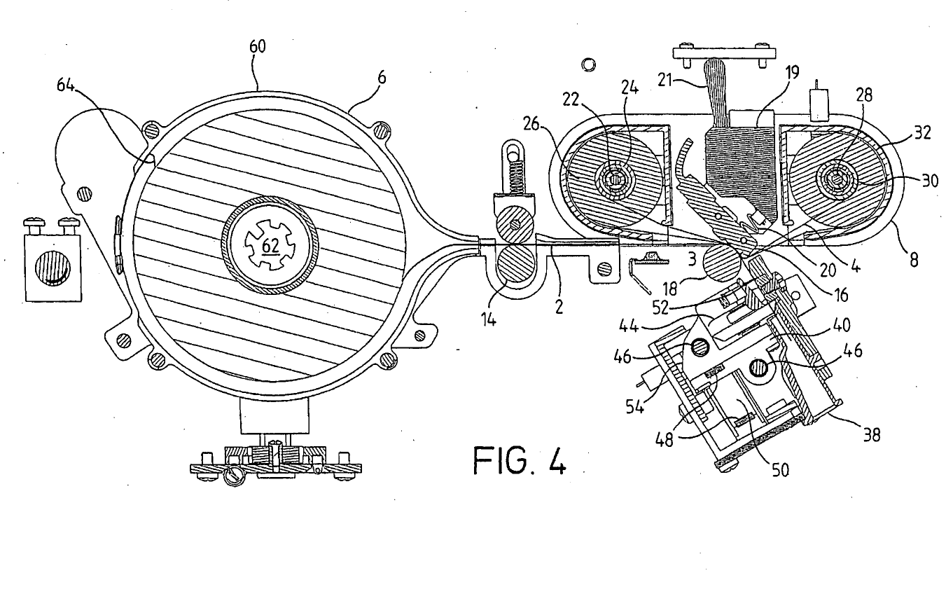

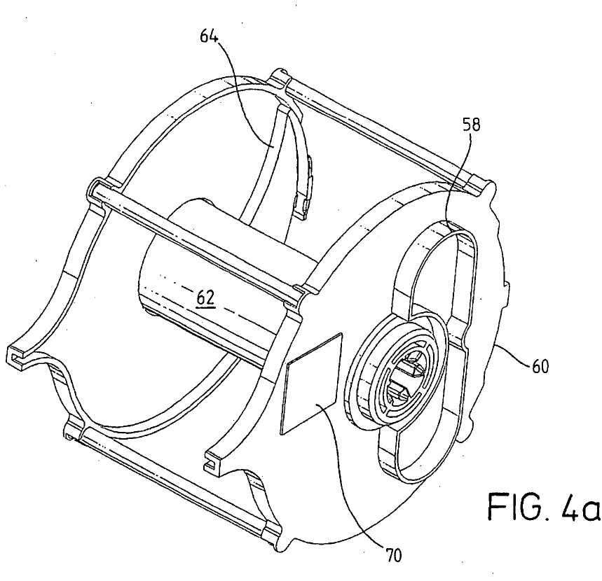

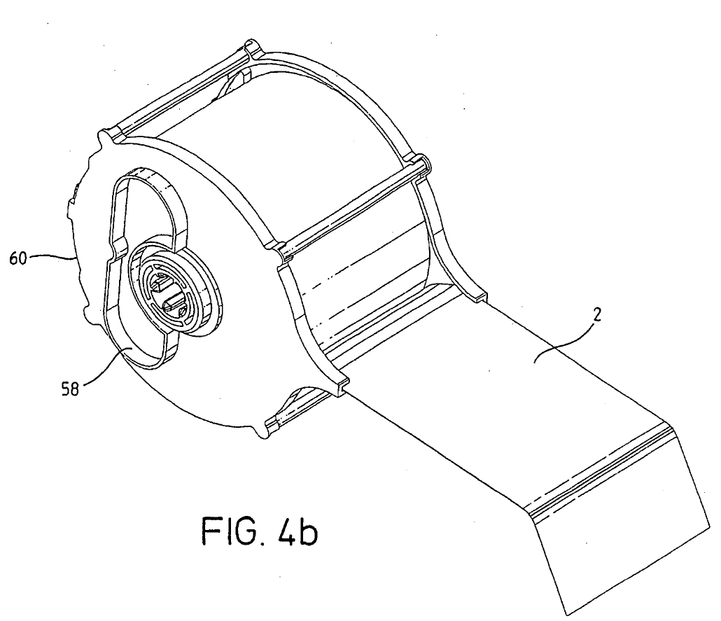

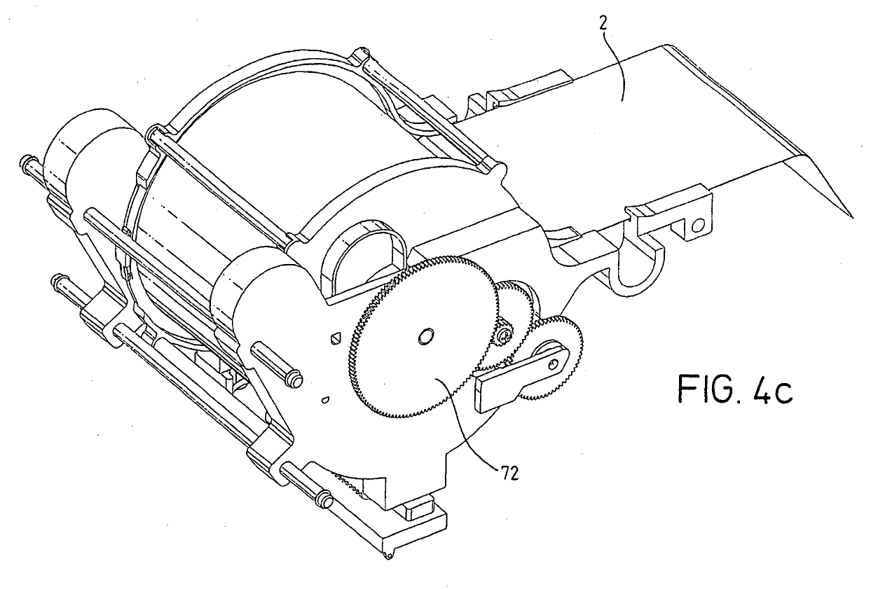

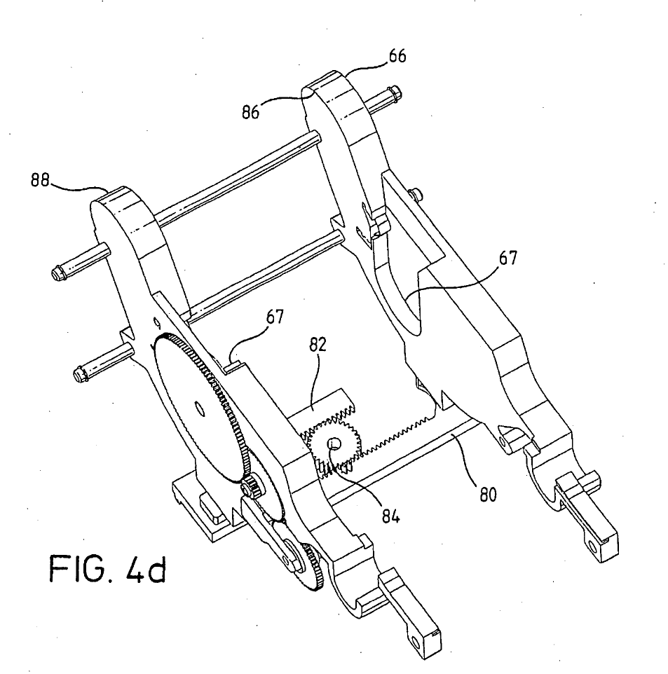

FIG. 4 is a cross-sectional view of the mechanical arrangement of the printing apparatus taken along line AA of FIG. 1;

FIGS. 4A and 4B are perspective views from different angles of a tape holder, Figure C is a perspective view of a tape holder housed in a receiving part of the printing apparatus and FIG. 4D is a perspective view of the receiving part of the printing apparatus without the tape holder installed;

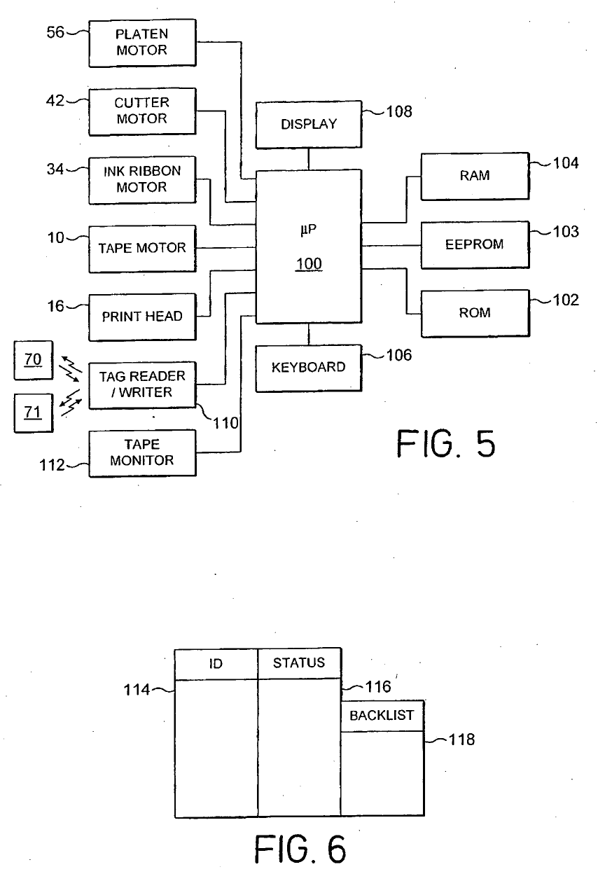

FIG. 5 is a schematic block diagram of control components of a printing apparatus;

FIG. 6 is a diagram of the memory structure;

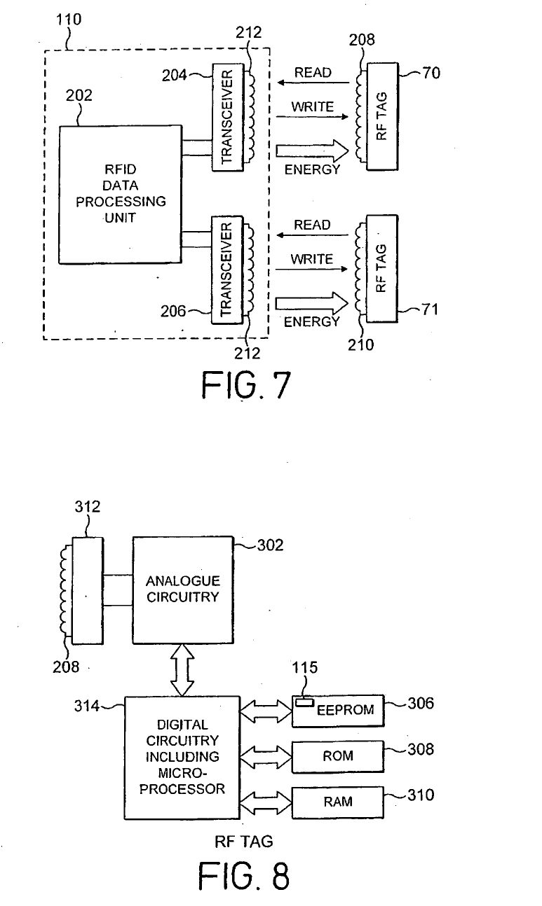

FIG. 7 is a diagram of a tag reader;

FIG. 8 is a diagram of an RF tag;

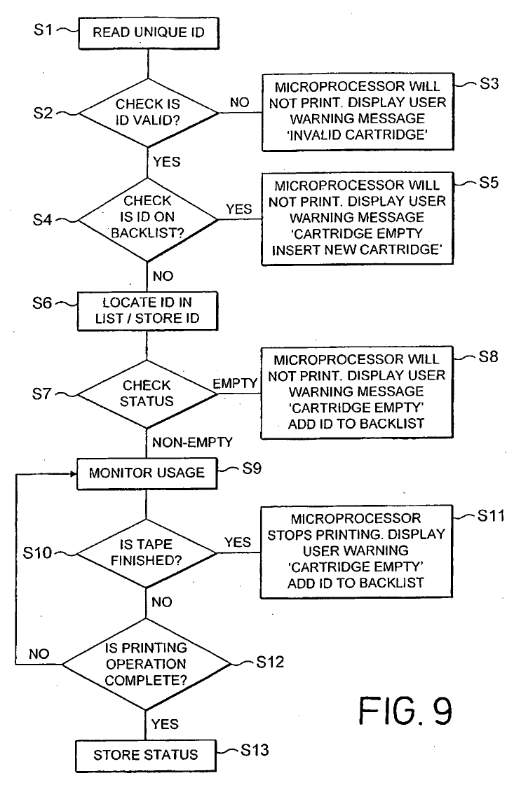

FIG. 9 is a flowchart of the authentication process;

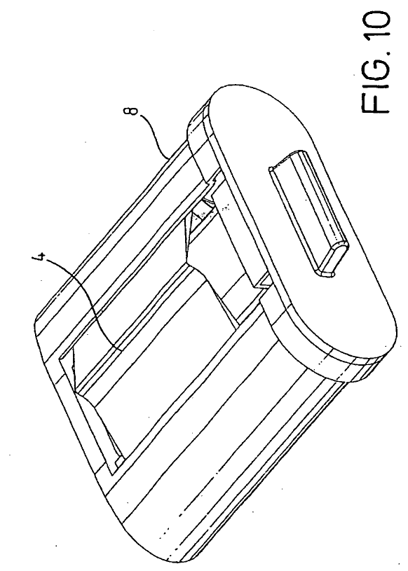

FIG. 10 is a perspective view of a ink ribbon cassette; and

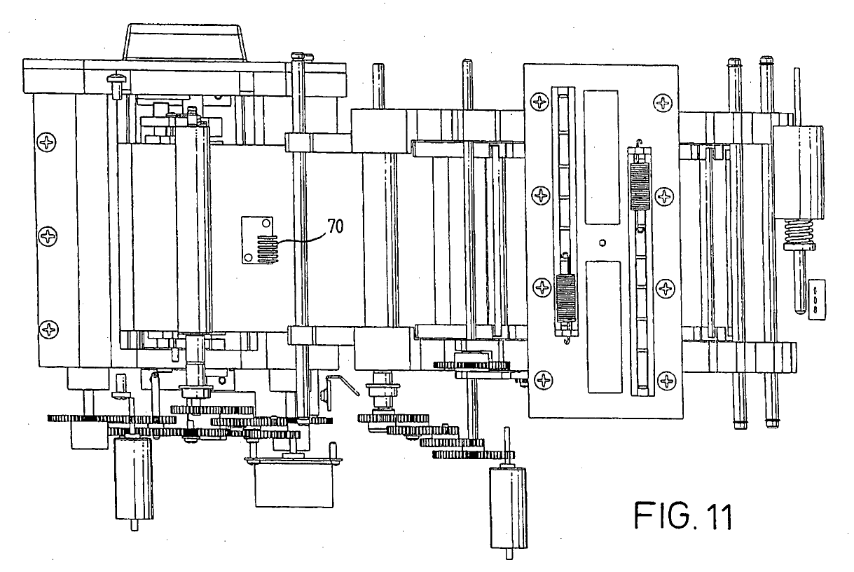

FIG. 11 is a plan view of the printing apparatus showing a photo-sensor.

The mechanical arrangement of the printing apparatus will now be described with reference to FIGS. 1 to 4. A label substrate comprises a tape 2 onto which images can be printed by a printing apparatus into which the label substrate is inserted. The tape 2 is housed on a tape holder 6, the details of which can most clearly be seen from FIGS. 4, 4a and 4b. The tape holder 6 comprises sides 60 and an inner spool 62 around which a supply of tape 2 is wound. The inner spool 62 may rotate within the tape holder 6 when tape is unwound. A spring clip 64 is attached to a flange on the tape holder and bears on the spool 62. The spring clip 64 prevents the tape from unwinding more than is required. An annular rib 58 is provided on each side of the tape holder 6 which allow it to be housed in a first receiving part 66 of the printing apparatus.

The first receiving part 66 is shown in FIG. 4D, and has side supports 86, 88 each having an inward facing recess 67 designed to accept the corresponding rib 58 of the tape holder 6. The first receiving part 66 is adjustable to accommodate different width holders as will now be explained. The supports 86 and 88 of the first receiving part 66 are connected to teethed arms 80 and 82. The teeth of teethed arms 80 and 82 engage with opposite edges of a cog 84. In this way any movement of one of the supports 86 or 88 is mirrored by the other support, so that each support is always an equal distance from a centre line A (shown in FIG. 1). This ensures that the tape will always be fed centrally to the print head, regardless of the width of the tape. The supports can be separated by a user to insert a holder, and then springs 74 (shown in FIG. 1) bring the supports together to grip the sides of the of the tape holder 6.

As shown in FIG. 4C, the receiving part 66 is provided with a gear chain 71 powered by a motor 10 (shown in FIG. 1) that drives the inner spool 62 of the tape holder in order to rewind the tape to allow the holder to be removed from the device.

The printing apparatus comprises a gear chain 12, powered by a motor 10, which drives the feed roller 14 which causes the tape from the tape holder 6 to move towards a print zone 3 of the printing apparatus. At the print zone, a print head 16 is biased against a platen roller 18 by a spring 20. The spring 20 is held within a print head mounting block 19.

An ink ribbon cassette 8 (shown in FIG. 10) holds an ink ribbon 4 and is similarly mounted in a second receiving part of the printing apparatus. It is mounted on shafts 22 and 28 of the printing apparatus. The mounting block 19 may be moved by means of an actuator 21 to separate the print head and the platen to allow the ink ribbon cassette 8 to be removed from the printer. Unused ink ribbon 26 is stored on a supply reel 24 mounted on a shaft 22. Used ink ribbon 32 is stored on a take-up reel 30 mounted on a shaft 28. A motor 34 powers a gear chain 36. When the motor 34 is driving forwards, a first set of gears 36c, 36d drive the shaft 28 to pull the ink ribbon 4 in a forward direction from the supply reel 24 to the take-up reel 30, and a slipping clutch (not shown) disengages the shaft 22 so that it is not driven, but is free to turn. When the motor 34 drives in reverse, a second set of gears 36a, 36b drive the shaft 22 to pull the ink ribbon 4 in a reverse direction from the take-up reel to the supply reel, and a slipping clutch (not shown) disengages the shaft 28 so that it is not driven, but is free to turn.

The ink ribbon cassette 8 is located in the printing apparatus so that the ink ribbon 4 has a path which extends through the print zone 3, and in particular extends in overlap with the tape 2 between the printhead 16 and the platen 18. The platen 18 is driven by a platen motor 56, to drive the tape through the print zone.

A cutting apparatus 40 is located downstream of the print zone 3. The cutting apparatus comprises a circular cutting blade or cutting wheel 44 mounted on a cutter holder 54. The cutting blade 44 cuts the tape 2 against an anvil 52. A cutter motor 42 drives the cutting wheel 44 from a rest position across the width of the tape. Once the cutting wheel 44 has traversed the entire width of the tape, the cutter motor 42 is reversed and drives the cutter holder 54 back to its rest position. The cutter holder 54 is slidably mounted on two sliders 46 which span the entire width of the tape 2. The cutter holder 54 is attached to a belt 48 which is supported by two rollers 50. One of the rollers 50 is driven by the cutter motor 42 to cause the cutter holder to move along the sliders 46.

The mechanical function of the printing apparatus will now be described. During feeding of the tape, the tape feed motor 10 is activated to drive the tape 2 past the printhead 16. Once the tape reaches the print zone, it is picked up by the platen 18, driven by the platen motor 56. At the same time, the ink ribbon motor 34 is activated to drive the ink ribbon at an equal speed to the tape. An image is transferred onto the image receiving tape 2 by virtue of activation (heating) of particular printhead elements to transfer ink from the ink ribbon 4 to the substrate 2 in a known manner. Images are printed on a column by column basis as the tape 2 is moved past the printhead 16. This printing technique is known per se and so is not described further herein.

When the printing on a label is finished, the platen motor 56 and the ink ribbon motor 34 continue to feed the tape and the ink ribbon a predetermined distance until the end of the label is at the required cutting position. The tape may then be cut by the cutting apparatus 40. Once cutting is complete, the tape 2 is reversed by reversing the platen motor 56 that drives the platen 18 in reverse until the tape 2 is in the correct position for printing the next label. Whilst the tape is reversed, the ink ribbon 4 is also reversed at the same speed by driving the ink ribbon motor 34 in reverse. This prevents the ink ribbon 4 rubbing against the tape 2 and becoming damaged.

A photo-sensor 76 shown in FIG. 11 is mounted on the frame of the printing apparatus and detects the presence of tape 2. This prevents the printer printing if there is no tape present in the printer.

FIG. 5 shows a schematic block diagram of the control components of the printing apparatus. A microprocessor 100 controls operation of the printing apparatus and is associated with a read only memory ROM 102, an electronically erasable programmable read only memory EEPROM 114 and a random access memory RAM 104. The printing apparatus includes a keyboard 106 for entering data (e.g. characters and symbols) and control commands for printing, and a display 108 for displaying to the user labels under edit, control commands, error messages, etc. The microprocessor 100 controls the printhead 16, tape drive motor 10, ink ribbon motor 34, cutter motor 42 and the platen motor 56.

A tape monitor 112 monitors usage of the tape. In order to monitor usage of the tape in one implementation, the rear of the substrate tape may be provided with markings indicative of the amount of tape remaining. For example, alternating black/white spaces (stripes perpendicular to the lengthwise direction of the tape) could be provided where the ratio of black to white, or the absolute width of the spaces, varies from the beginning to the end of the tape. This could be a continuous change or discrete change, in the latter case for example changing every quarter of the tape only to provide a rough indication of how much tape is left. Another possibility would be a line extending diagonally along the entire length of the tape such that at any point the distance of the line from an edge of the tape differs. In that case, the tape monitor can comprise a reader for reading these markings. A suitable reading device is described for example in our U.S. patent application Ser. No. 09/284,236 and suitable markings for usage indication are described in our U.S. patent application Ser. No. 09/0141059.

A further alternative is to provide an end of tape detection, for example by providing silvering at the end of the substrate tape 2, which can be optically detected by the printing apparatus. Other end of tape detection means are know, for example using the encoded pulses from a feed motor shaft to sense if the shaft has stopped turning, due to reaching the end of the tape.

Usage of the ink ribbon in the ink ribbon cassette can be monitored in a known way, for example as described in U.S. Pat. No. 5,821,975.

A cassette reader 110, also shown in FIG. 7, is also provided in the printing apparatus. The purpose of this reader is to read identifiers from tape holders and ink ribbon cassettes that are inserted into the printing apparatus. Each tape holder 6 and ink ribbon cassette 8 manufactured legitimately for use with a printing apparatus of the type described herein carries a unique identifier which uniquely identifies that particular tape holder or ink ribbon cassette and contents. In the described embodiment, this is carried on an RF tag 70 on the tape holder 6 and the RF tag 71 on the ink ribbon cassette 8, the two tags being readable by a cassette reader 110 to read the unique identifier. The reader takes the form of a RFID data processing unit 202 that controls transceivers 204 and 206. A transceiver 204 communicates via an RF coil 212 with a coil 208 implemented at the tag 70 mounted on the tape holder 6, by way of electromagnetic radio frequency waves. A transceiver 206 communicates via an RF coil with a coil 210 implemented at the tag 71 mounted on the ink ribbon cassette 8. The signal communicated is encoded in a known way by modulating an RF carrier. The RF tags 70, 71 are passive devices that receive energy from the cassette reader 110 whenever they are accessed.

The cassette reader 110 is located in the printer so that it can read the signal from the tags 70 and 71, even though they are not at the same location. The RFID DPU 202 switches between the transceivers 204, 206 depending on which tag is to be read.

FIG. 8 shows a schematic of the RF tag 70. RF tag 71 is designed to work in a similar fashion. An RF coil 208 is provided to receive control signals and power from the cassette reader 110. The signals are received by digital circuitry 304, which includes a microprocessor, via analogue circuitry 302. The digital circuitry 304 has access to EEPROM 306, ROM 308 and RAM 310. The unique identifier 115 is stored in the EEPROM, and can be programmed during fabrication.

A working part of the EEPROM 103 is organised as shown in FIG. 6 to implement the authentication techniques discussed below. That is, the EEPROM 103 has a structure which allows each unique identifier (ID) to be associated with a particular status. There is a structure comprising a column of ID fields 114 associated with tape holders and ink ribbon cassettes, and a number of corresponding status fields 116. In addition, the EEPROM 103 holds a blacklist 118. Operation of the authentication technique implemented in the processor is illustrated in the flow chart of FIG. 9. When a tape holder or ink ribbon cassette is inserted into a printing apparatus, the cassette reader 110 identifies (step S1) from the RF ID tag 70 or 71 the unique identifier 115 for that tape holder or ink ribbon cassette. It is firstly ascertained that the unique identifier is a valid identifier by an authentication process (step S2) carried out in the microprocessor 100. If it is not a valid identifier an invalid indication is generated and the microprocessor will not print, and the user receives a warning message on the display 108 “INVALID CARTRIDGE” (step S3).

If it is a valid identifier, it is checked (step S4) against a blacklist of identifiers 118, which is a list of identifiers of tape holders that have previously used in that printing device. This guards against a third party illegitimately manufacturing a tape holder and copying the identifier of that tape holder in the hope of replacing a legitimate tape holder which has already been used. If the cartridge has already been used and emptied, an invalid indication is generated and the microprocessor will not implement printing operations. The display is caused to display a warning message (step S5): “CARTRIDGE EMPTY—INSERT NEW CARTRIDGE”.

If the tape holder is identified as having a valid identifier which is not on the blacklist, then the entry in the list for the identifier 115 is found, or in the case of a new cartridge, the identifier 115 is stored (step S6) in the ID field 114 with a status of “non-empty”. If the cartridge has previously been used in the printer, the status that is stored for that particular cartridge identifier is checked in step 7. If the status is “empty” the warning message “CARTRIDGE EMPTY—INSERT NEW CARTRIDGE” is shown and the identifier is moved to the blacklist. As tape is consumed in operation of the printing apparatus, the usage is monitored (step S9) and the status field is updated (step S13), either continually or after each printing operation (step S12), to indicate the amount of tape remaining. Step 10 allows for the case when the tape runs out during a print operation, resulting in a warning message (step 11) and the identifier being removed to the blacklist. After completion of a print job the status of the cartridge is stored, and the tape may then be removed. If the tape is subsequently reinserted, the sequence will start again at S1, and the status previously stored will be located in step S6 and checked in step S7.

It is possible for the RF ID tag to hold contact information for suppliers or distributors of the cartridge. In addition to the unique identifier inserted at the factory or other manufacturing location, the distributor or supplier could include their telephone number, website URL etc in the tag. This would allow a message to be displayed of a type combining the information about the amount of tape or labels remaining with information about the distributor or supplier, for example a message such as:
“you have only x labels left, reorder tape now at website y”
   or
“call-your dealer at telephone number z”.

It will be appreciated that the present invention applies to continuous tape consumables described above, as well as to consumables in the form of a backing sheet to which are adhered die cut labels.

Thus the consumable can be manufactured by applying an identifier at the original manufacturing location, e.g. a factory, and a secondary identifier at a secondary location, e.g. a distributor or supplier with contact information about the distributor or supplier.

1.-20. (canceled)

21. A consumable comprising:
at least one material selected from the group consisting of image receiving substrate and thermal transfer material,
a first identifier indicative of the origin of the consumable, and
a second identifier indicative of the supplier of the consumable.

22. A method of making a consumable comprising at least one material selected from the group consisting of an image receiving substrate and thermal transfer material, the method comprising:
at a manufacturing location marking the consumable with a first identifier indicative of the origin of the consumable; and
at a secondary location, marking the consumable with a second identifier indicative of the supplier the consumable.

23. A method of operating a printing apparatus which is adapted to receive a consumable, the method comprising:
reading an identifier from the consumable, comparing the identifier against a list of any previously used identifiers associated with empty consumables, and
generating an invalid indication if there is a match.

24. A method according to claim 23, further comprising:
reading a secondary identifier from the consumable, the secondary identifier identifying a supplier of the consumable, and
displaying information about the supplier of a consumable.

25. A printing apparatus using a consumable associated with an identifier, the apparatus comprising:
a printer mechanism for printing an image onto an image receiving substrate;
a reader for reading the identifier;
a storage medium for holding a list of any previously used identifiers associated with empty consumables; and
a processor arranged to compare the identifier read by the reader with the list of any previously used identifiers and to generate an invalid indication if there is a match.

26. A printing apparatus according to claim 25, wherein the reader comprises an RF coil.

27. A printing apparatus according to claim 25, wherein the storage medium is arranged to hold a table comprising a plurality of identifier fields associated with respective status fields.

28. A printing apparatus according to claim 26, wherein the storage medium is arranged to hold a table comprising a plurality of identifier fields associated with respective status fields.

29. A printing apparatus according to claim 27, wherein the processor is arranged to load into one of said identifier fields an identifier read by the reader which does not match a previously used identifier.

30. A printing apparatus according to claim 28, wherein the processor is arranged to load into one of said identifier fields an identifier read by the reader which does not match a previously used identifier.

31. A printing apparatus according to claim 25, further comprising a usage monitor for monitoring the usage of the consumable.

32. A printing apparatus according to claim 31, wherein the processor is arranged to update the status field to indicate the amount of consumable remaining based on the usage monitored by the usage monitor.

33. A printing apparatus according to claim 25, wherein the consumable comprises a supply of an image receiving substrate.

34. A printing apparatus according to claim 31, wherein the usage monitor comprises an end of substrate detector.

35. A printing apparatus according to claim 25, wherein the consumable comprises a supply of thermal transfer material.

36. In combination, a printing apparatus and a consumable associated with an identifier, wherein the printing apparatus comprises:
a printer mechanism for printing an image onto an image receiving substrate;
a reader for reading the identifier;
a storage medium for holding a list of any previously used identifiers associated with empty consumables; and
a processor arranged to compare the identifier read by the reader with the list of any previously used identifiers and to generate an invalid indication if there is a match.

37. A combination according to claim 36, wherein the consumable comprises a cassette in which the image receiving substrate is housed.

38. A combination according to claim 36, wherein the consumable comprises a spool around which the image receiving substrate is wound.

39. A combination according to claim 36, wherein the consumable comprises a supply of thermal transfer material.

40. A consumable comprising:
at least one material selected from the group consisting of image receiving substrate and thermal transfer material,
a first identifier which uniquely identifies the consumable, and
a second identifier indicative of the supplier of the consumable.

41. A consumable comprising:
at least one material selected from the group consisting of image receiving substrate and thermal transfer material,
a first identifier programmed during fabrication, and
a second identifier additionally inserted to the first identifier and including information indicative of the supplier of the consumable.

42. A consumable according to claim 41, wherein the information indicative of the supplier of the consumable is contact information of the supplier.

43. A consumable according to claim 21, wherein said first and second identifiers are carried on the same tag.

44. A consumable according to claim 22, wherein said first and second identifiers are carried on the same tag.

45. A consumable according to claim 40, wherein said first and second identifiers are carried on the same tag.

46. A consumable according to claim 41, wherein said first and second identifiers are carried on the same tag.

47. A consumable according to claim 43, wherein said tag is an RF tag.

48. A consumable according to claim 44, wherein said tag is an RF tag.

49. A consumable according to claim 45, wherein said tag is an RF tag.

50. A consumable according to claim 46, wherein said tag is an RF tag.

51. A method of making a consumable comprising:
at least one material selected from the group consisting of an image receiving substrate and thermal transfer material, the method comprising:
marking the consumable with a first identifier which uniquely defines the consumable, and additionally marking the consumable with a second identifier indicative of the supplier of the consumable.

52. A method of making a consumable comprising at least one material selected from the group consisting of an image receiving substrate and thermal transfer material, the method comprising:
marking the consumable with a first identifier during manufacturing; and
inserting additionally to the first identifier a second identifier, including information indicative of the supplier of the consumable.
